(19) United States
(12) Patent Application Publication
(10) Pub. No.: US 2012/0228396 A1
(43) Pub. Date: Sep. 13, 2012

(54) System and Method for Optimizing the Dissolution of a Gas in a Liquid

(76) Inventors: Gregory Scott Osborn, Fayetteville, AR (US); Larry K. Linguist, Denham Springs, LA (US)

(21) Appl. No.: 13/415,402

(22) Filed: Mar. 8, 2012

Related U.S. Application Data
(63) Continuation-in-part of application No. 11/921,057, filed on Nov. 7, 2008.
Application No. 11/921,057 is a continuation-in-part of application No. 11/137,856, filed on May 25, 2005, now Pat. No. 7,255,332.
(60) Provisional application No. 60/574,152, filed on May 25, 2004.
(60) Provisional application No. 61/450,364, filed on Mar. 8, 2011.

(51) Int. Cl. B05B 17/04; B01F 3/04

(52) U.S. Cl. 239/11; 261/76

(57) ABSTRACT

Systems and methods for optimizing and controlling the dissolution of ozone or other gas in a liquid within a pressure vessel by regulating vessel pressure, flow rate of a liquid into the vessel, retention time of the gas and liquid in the vessel, gas flow rate, liquid spray pattern, and internal mixing within the vessel are disclosed. The optimal operating vessel pressure, flow rate of the liquid, retention time of the gas and liquid in the vessel, gas flow rate, liquid spray pattern, and internal mixing within the vessel may be determined based on the operating characteristics of an ozone generator.

### CROSS-REFERENCE TO RELATED APPLICATIONS

This application is a continuation-in-part application of, and claims the benefit of, U.S. patent application Ser. No. 11/921,057, filed Nov. 7, 2008, which is a continuation-in-part of U.S. patent application Ser. No. 11/137,856, filed May 25, 2005 and now issued as U.S. Pat. No. 7,255,332, which in turn claims priority to U.S. Provisional Patent Application No. 60/574,152, filed on May 24, 2004. This application also claims the benefit of U.S. Provisional Patent Application No. 61/450,364, filed Mar. 8, 2011, and entitled “System and Method for Optimizing The Dissolution of a Gas in a Liquid.” The disclosures of each of the above-referenced applications are herein incorporated by reference in their entirety.

### STATEMENT REGARDING FEDERALLY SPONSORED RESEARCH

Research and development of the invention described in this disclosure has been supported, at least in part, by a grant from the National Institutes of Health (grant number 2R32ES014137-02). The United States Government has certain rights in the invention.

### BACKGROUND OF THE INVENTION

1. Field of the Invention

This invention relates to systems and methods for optimizing the dissolution of a gas in a liquid. More specifically, this invention is directed to systems and methods for optimizing and controlling the dissolution of ozone or other gas in a liquid by regulating and varying vessel pressure, flow rate of the liquid, retention time of the gas and liquid in a pressure vessel, gas flow rate, liquid spray pattern, and internal mixing within the pressure vessel.

2. Background of the Related Art

Many different systems and methods are available for dissolving gases in liquids and are highly dependent on the needed application. Some of the main applications that require dissolving gases into liquids include the oxygenation of outdoor water bodies, industrial uses, and the treatment of wastewater. Most dissolved gas delivery methods—bubble diffusion, Venturi injection, U-tubes, and Speece cones, for example—are based on increasing the contact time or surface area of gas bubbles introduced into a bulk liquid to enhance mass transfer. Previous technologies for dissolving gas into a liquid have features that increase the contact time or contact area between gas bubbles and the bulk fluid to increase dissolution.

Most, if not all, of these earlier technologies require recovery systems for off-gases that do not dissolve into the fluid or allow loss of undissolved gases. For example, U.S. Pat. No. 5,979,363 to Shaar describes an aquaculture system that involves piping a food and oxygen slurry into a pond. U.S. Pat. No. 5,911,870 to Hough discloses a device for increasing the quantity of dissolved oxygen in water and employs an electrolytic cell to generate the oxygen. U.S. Pat. No. 5,904,851 to Taylor discloses a method for enriching water with oxygen that employs a Venturi-type injector to aspirate gas into a fluid, followed by mixing to increase dissolution. U.S. Pat. No. 5,885,467 to Zelenak discloses mixing a liquid with oxygen using a plurality of plates or trays over which the liquid flows gradually downward. U.S. Pat. No. 4,501,664 to Heil discloses a device for treating organic wastewater with dissolved oxygen that employs several process compartments. U.S. Pat. No. 5,766,484 to Petit describes a dissolved gas flotation system for treatment of wastewater wherein the relative location of inlet and outlet structures reportedly maximizes the effect of air bubbles in separating solids from the fluid. U.S. Pat. No. 5,647,977 to Arnaud describes a system for treating wastewater that includes aeration, mixing/flocculating, and contact media for removing suspended solids. U.S. Pat. No. 5,382,358 to Yeh discloses an apparatus for separation of suspended matter in a liquid by dissolved air flotation. And U.S. Pat. No. 3,932,282 to Ettelt discloses a dissolved air flotation system that includes a vertical flotation column designed with an aim of preventing bubble breakage.

Mazzei injectors (see, e.g., U.S. Pat. Nos. 5,674,312; 6,193,893; 6,730,214) use a rapid flow of water to draw gas into the fluid stream; mixing chambers may or may not be used to increase contact time between the gas bubbles and the fluid to increase dissolution. The system described in U.S. Pat. No. 6,530,895 to Keirn has a series of chambers under pressure that add gaseous oxygen to fluid; the pressure increase and the chambers in series are used to increase dissolution. U.S. Pat. No. 6,962,654 to Arnaud describes a system that uses a radially grooved ring to break a stream of fluid into smaller streams; gas is introduced into the streams and mixing is used to increase dissolution. Speece (see U.S. Pat. Nos. 3,643,403; 6,474,627; 6,485,003; 6,848,258) proposes the use of head pressure to introduce liquid under pressure into a conical chamber; the downward flow of the fluid is matched in velocity to the upward flow of gas bubbles to increase dissolution time. Littman et al. (U.S. Pat. No. 6,279,882) uses similar technology to Speece except that the upward flowing bubble size is decreased with a Shockwave. Roberts, Jr. et al. (U.S. Pat. No. 4,317,731) propose turbulent mixing in an upper chamber to mix gas with a bulk fluid; a quiescent lower chamber allows undissolved gas to rise back into the upper chamber for remixing.

Other U.S. patents describe various methods of increasing the contact time between gas bubbles in fluids, including U.S. Pat. No. 5,275,742 to Satchell; U.S. Pat. No. 5,451,349 to Kingsley; U.S. Pat. No. 5,865,995 to Nelson; U.S. Pat. No. 6,076,808 to Porter; U.S. Pat. No. 6,090,294 to Teran; U.S. Pat. No. 6,503,403 to Green; and U.S. Pat. No. 6,840,983 to McNulty. Spears, et al. (U.S. Pat. Nos. 7,294,278; 7,008,535) describe a method for varying the dissolved oxygen concentration in a liquid by varying the pressure from 14.7 to 3000 psi inside an oxygenation assembly. Patterson, et al. (U.S. Pat. No. 6,565,807) describe a method for maintaining, adjusting, or otherwise controlling the levels of oxygen dissolved in blood (e.g., pO₂) by controlling the flow rates or by providing controlled amounts of the blood or oxygen gas.

These conventional systems for dissolving gases in liquids, and in particular conventional dissolved ozone delivery systems are based on dissolving bubbles into stationary or flowing water and are greatly limited in the range of dissolved ozone concentration that can be attained and controlled. These conventional systems are also limited to nearly steady-state use, and cannot quickly adjust dissolved ozone concentrations to optimize water treatment. Bubble-based technology is limited to much lower dissolved ozone concentration in the water being treated because of lower pressure and less-efficient gas transfer.

Accordingly, there is a need for systems and methods for optimizing the dissolution of a gas into a liquid, and in particular for systems that can quickly adjust dissolved ozone concentrations to levels that are optimal for water treatment processes. The systems and methods described in this disclosure meet this need.

### SUMMARY OF THE INVENTION

This document discloses systems and methods for optimizing and controlling the dissolution of ozone or other gas in a liquid within a pressure vessel by regulating vessel pressure, flow rate of a liquid into the vessel, retention time of the gas and liquid in the vessel, gas flow rate, liquid spray pattern, and internal mixing within the vessel. The optimal operating vessel pressure, flow rate of the liquid, retention time of the gas and liquid in the vessel, gas flow rate, liquid spray pattern, and internal mixing within the vessel may be determined based on the operating characteristics of an ozone generator.

In one exemplary embodiment, the present invention is directed to a system for optimizing the dissolution of a gas in a liquid comprising: (a) a dissolution tank comprising: (i) a pressure vessel for containing a treated fluid and providing a regulated gas head space comprising at least one gas above the treated fluid, (ii) at least one liquid spray nozzle that permits passage of an untreated fluid into the gas head space under conditions effective to dissolve the gas in the untreated fluid, and (iii) an outlet that permits passage of the treated fluid out of the pressure vessel; (b) means for passing the untreated fluid into the dissolution tank in communication with the at least one liquid spray nozzle; (c) a gas source in communication with the dissolution tank; (d) a discharge device external the dissolution tank in communication with the outlet, which discharge device is provided with at least one orifice through the treated fluid from the dissolution tank can be released into the target liquid external the discharge device; and (e) at least one control device in communication with the dissolution tank.

In another exemplary embodiment, the present invention is directed to a method for optimizing the dissolution of a gas in a liquid, the method comprising the steps of: (a) pressurizing an enclosed vessel with gas from a gas generator; (b) spraying an untreated liquid into the vessel containing the gas under conditions effective to dissolve the gas in the untreated liquid; (c) discharging a treated liquid from the vessel into a target liquid; (c) interfacing at least one control device with the vessel, wherein the at least one control device is capable of adjusting at least one parameter; and (e) adjusting at least one parameter within the pressure vessel, wherein said adjustment is effective to change the amount of gas dissolved in the liquid held in the vessel.

### BRIEF DESCRIPTION OF THE DRAWINGS

So that those skilled in the art will readily understand how the methods and systems for optimizing the dissolution of a gas into a liquid function, preferred embodiments of the systems and methods are described in detail below with reference to the following figures:

FIG. 1 is a schematic diagram of the system of the present invention illustrating a system for treatment of a natural stream with a generic gas.

FIG. 2(a)-(c) is a data table and two graphs showing the manufacturer's performance results of an ozone generator output of ozone concentration and ozone flow rate as gas flow rate and pressure changes. The specific ozone generator is a Model Titan 80 manufactured by Absolute Ozone.

FIG. 3(a)-(b) is two graphs showing the manufacturer's performance results of an ozone generator output of ozone concentration and ozone flow rate as gas flow rate and pressure changes. The specific ozone generator is manufactured by Pinnacle Ozone Solutions.

### DETAILED DESCRIPTION OF PREFERRED EMBODIMENTS

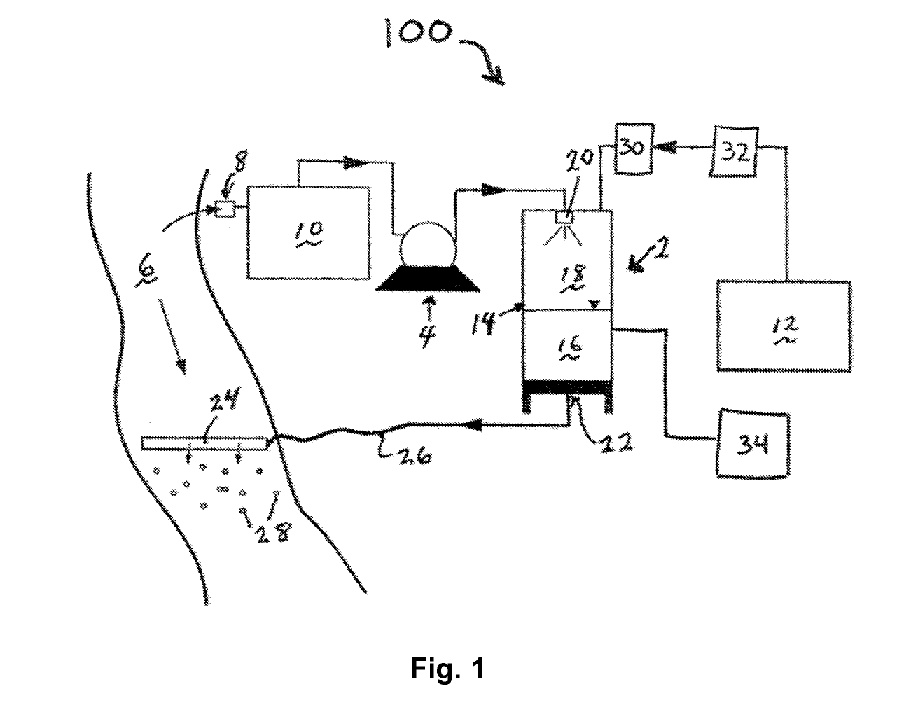

Reference will now be made in detail to the present preferred embodiments of the systems and methods for optimizing the dissolution of a gas into a liquid. For purposes of explanation and illustration, and not limitation, an exemplary embodiment of an optimization system in accordance with the present invention is shown in FIG. 1 and designated generally by the reference numeral 100. System 100 includes a dissolution tank 2, and a pump 4 in fluid communication with the dissolution tank. Fluid flows into pump 4 from a stream or other fluid source 6. In one exemplary embodiment, the fluid enters through an intake passage, into a filter 8 and into a supply tank 10 before flowing into pump 4.

A gas source 12 is also in fluid communication with dissolution tank 2 and is configured to supply a quantity of gas to dissolution tank 2. In one exemplary embodiment, dissolution tank 2 includes a pressure vessel 14 for containing treated fluid 16 and providing a gas headspace 18 above the treated fluid. In one exemplary embodiment, gas headspace 18 is at a super-atmospheric pressure. Dissolution tank 2 may also include one or more liquid spray nozzles 20, configured to inject fluid being pumped from pump 4 into pressure vessel 14 of dissolution tank 2. Dissolution tank 2 may also include an outlet 22, configured to permit the gasified fluid 16 to flow through a connecting means 26 and into a discharge device 24. In one exemplary embodiment, discharge device 24 is positioned within a stream 6 downstream of the intake passage. The now-gasified fluid may then be discharged into stream 6, for example by passing through one or more outlet orifices in discharge device 24. As a result of the fluid passing through system 100, dissolved gas 28 is released into stream 6. Dissolved gas 28 is preferably oxygen, ozone, hydrogen, nitrogen, nitrous oxide, or carbon dioxide. The liquid is typically composed primarily of water.

In addition to the components described above, system 100 may also include a pressure regulator 30 and a generator 32 situated between gas source 12 and pressure vessel 14 such that the gas flowing from gas source 12 passes through generator 32 and pressure regulator 30 before entering pressure vessel 14. Generator 32 and pressure regulator 30 may be arranged in either order, that is, system 100 may also be configured such that the gas flows through pressure regulator 30 first and then through generator 32. System 100 may also include one or more programmable logic controllers or other control devices 34 interfacing with system 100 to allow for automated adjustment of various parameters within system 100, including, but not limited to, pressure within vessel 14, flow rate of the fluid 16 into and out of pressure vessel 14, retention time of gas and liquid in vessel 14, gas flow rate into vessel 14, the liquid spray pattern from spray nozzles 20, and the rate of internal mixing within vessel 14.

Although the schematic shown in FIG. 1 shows control device 34 connected to pressure vessel 14, it should be understood that system 100 may include a plurality of control devices 34 interfacing with any of the various parts of system 100 and with each other. Control devices 34 may be hard-wired or they may operate wirelessly, and may be able to be controlled remotely through a network. In addition, control devices 34 may be any suitable device, including mechanical or other manually operated devices.

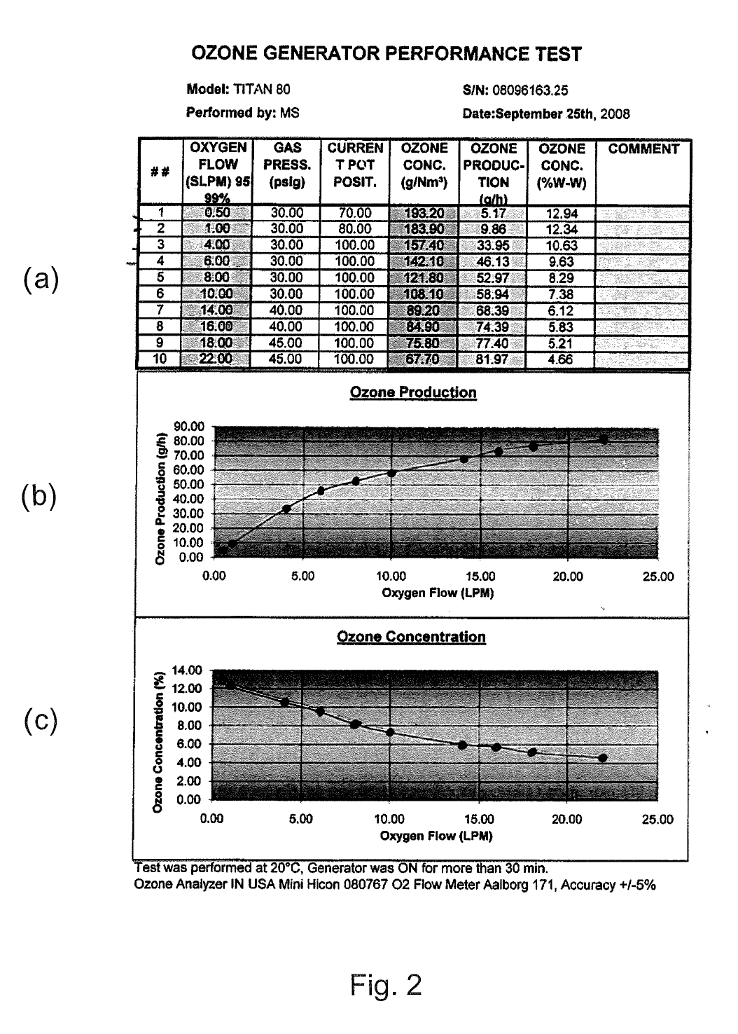

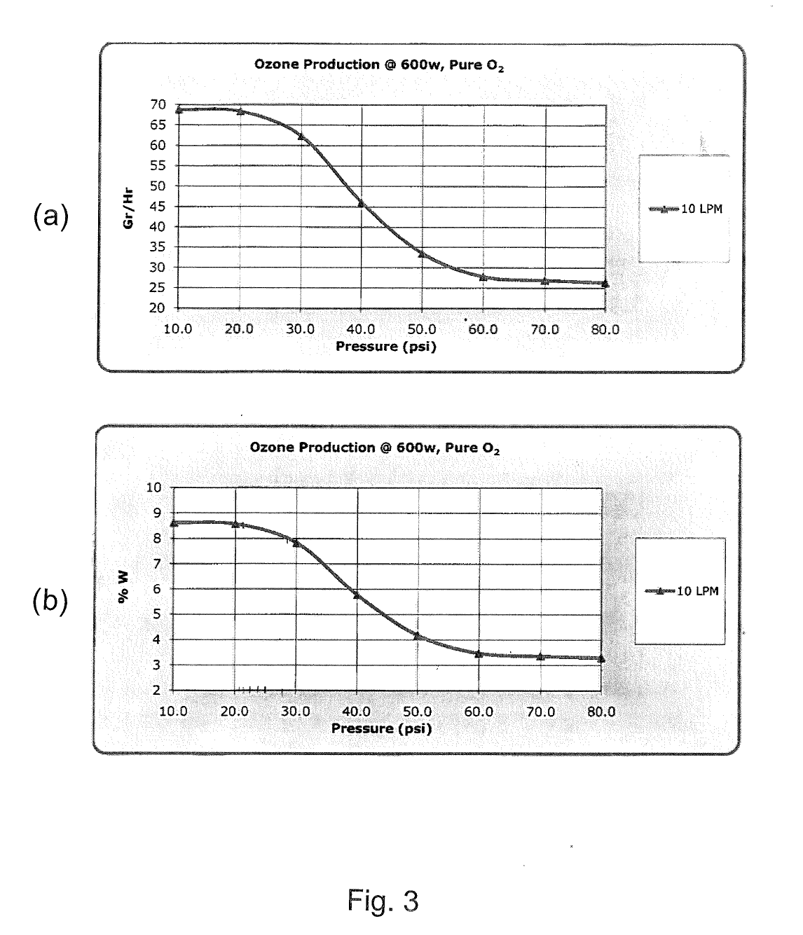

The present invention is directed to a method for controlling and manipulating the settings of the system 100, in part, to optimize the operation of the ozone generator feeding ozone gas to the system 100. Optimization of the ozone generator is to minimize operating cost and/or capital cost and/or footprint. Each ozone generator design may have a different operating characteristic curve of ozone concentration in the gas vs. feed gas flow rate. The overall mass flow rate output of ozone being generated also varies as feed gas flow rate changes. FIGS. 2-3 illustrate this phenomena for two typical ozone generators on the market. In FIG. 2, the Titan 80 ozone generator manufactured by Absolute Ozone shows a decrease in ozone concentration as feed oxygen gas flow rate increases, but an increase in overall ozone production rate as feed gas flow increases. FIG. 3 shows curves for an ozone generator manufactured by Pinnacle Ozone Solutions. The Pinnacle unit shows a decrease in concentration of ozone as pressure increases. By using the current invention, the optimal operating points of these two different ozone generators can be reached by adjusting the operating parameters of the invention. As pressure of the gas and liquid in the invention increases, the dissolved ozone concentration increases in the water being delivered for treatment. However, the ozone generator in FIG. 3 shows that as pressure increases, the concentration of ozone produced decreases. Therefore, the effect of pressure on total dissolve ozone concentration delivered for treatment has the opposite effect on the components of the system of the ozone generator and the invention that dissolves the gas into the liquid. Experiments conducted indicated that the economically optimum dissolved ozone concentration was reached when the pressure was 30 psi for the overall system. The overall economics of the system include capital cost of the ozone generators as well as operating costs of power for the invention and the ozone generator and oxygen feed gas. The same analysis showed that for the Absolute Ozone generator shown in FIG. 2, the economically optimum pressure was reached at 40 psi because of the different characteristics of the ozone generator. The invention allowed for the operating characteristics of the system to be adjusted to account for the different characteristics of each ozone generator in order to reach an overall cheaper system for delivering dissolved ozone accounting for capital and operating costs. The ozone dissolved in the water exiting the system 100 can be controlled by adjusting the operating parameters of the system 100 such as pressure, water flow rate, water retention time, water spray pattern, and others in order to provide a wide range of dissolved ozone concentration in the water being delivered to the treatment site. Each treatment site will vary regarding the concentration of ozone required to perform the desired function such as disinfection, oxidation, solids reduction etc. Typically, the higher the concentration of dissolved ozone, the faster the disinfection/oxidation treatment. Therefore, a higher concentration of ozone could lead to a shorter contact time within a treatment process. For some processes, a shorter contact time could lead to process improvements resulting in lower cost or better treatment. Some applications may not benefit from a higher concentration of dissolved ozone allowing operating parameters to be adjusted to provide the lowest overall cost of treatment including minimizing the costs of feed gas, and electricity to both the ozone generator and the system 100. Given that the concentration of dissolved ozone in water can be varied independently from the ozone generator by adjusting operating parameters of the system 100, by adjusting the system 100 to provide the treatment required while minimizing the operating cost and/or capital cost and/or footprint of the ozone generator, the overall economics of the treatment system can be minimized beyond what can be attained by adjusting the ozone generator alone.

These cost benefits could be highly valuable for reducing the overall cost of ozone treatment of water. Ozonation has many advantages over current water treatment methods such as chlorination and Ultra Violet light treatment such as removing drug residuals, endocrine disruptors and other emerging contaminants that other treatment options will not remove. The main factor holding back widespread adaptation of ozonation is cost. Any method that can significantly reduce the cost of ozone treatment could result in a substantial increase in use of ozonation equipment.

The system 100 is effective for dissolution of ozone gas into water. The ozonated water contains a supersaturated concentration of dissolved ozone such that when the stream of water enters a body of water sufficient dissolved ozone is added to treat the entire larger body of water at a dissolved ozone concentration below that of the supersaturated stream from the system 100. Dissolved ozone is used to oxidize targets to either kill living organisms (e.g. viruses, cysts, bacteria, protozoa, algae) or oxidize chemicals to convert undesirable chemicals to more desirable ones.

The process of oxidation in practical water treatment occurs at a rate greatly dependent upon the chemistry of the target being oxidized and varies greatly and can range from milliseconds to several minutes. For a specific target, the oxidation rate for treatment depends on the concentration of dissolved ozone, concentration of target chemical and constituents in the water other than the target that contain competing sites for oxidation and other characteristics of the water such as pH, salinity, and temperature. To properly design treatment regimes for reducing target organisms and compounds to acceptably low concentrations requires quantification of the rate of reaction and the time period over which the reaction must occur (contact time) to result in completed treatment. Equations to quantify the oxidization rate from ozonation can be simple or complex and described by zero, first, second order kinetics and/or other more complex relationships. Once a relationship for reaction (or treatment) rate is established, contact time is determined by assuming a maximum design concentration of the target and a design concentration indicating completion of treatment.

Often, the rate of the oxidation reaction is not constant during the treatment process such as when the reaction rate is dependent upon the concentration of the target organism or compound. In these cases, integral calculus, numerical methods, or other complex methods must be used to determine contact time. However, this complexity is simplified for ozonation treatment of wastewater and drinking water by using the Ct concept. The term “C” represents concentration of ozone and “t” is time. Using this approach, a worst-case organism or chemical in the water is identified and the worst-case untreated concentration is assumed. Ct is determined by exposing the water to a steady-state concentration of ozone and measuring the time to completely treat the water for the worst-case target chemical. The Ct value is then used for regulation such that the requirement for water treatment is that a specific Ct in the design must be met to provide proper treatment. As concentration of dissolved ozone increases the contact time decreases correspondingly. The Ct concept does not predict the concentration of the target at any time during the process. It has been effective as a conservative design standard to ensure proper contact time has been reached for completed water treatment using dissolved ozone.

The Ct concept is not useful for designing ozonation water treatment systems optimized to remove several targets simultaneously at the lowest capital and operating cost. For example, a specific regulatory Ct value of 10 can be met by exposing the water to ozone concentrations 0.5 mg/L for 20 minutes or 10 mg/L for 1 minute. These two treatment options could have very different capital and operating costs for the equipment and infrastructure to deliver the Ct and also result in very different post treatment concentrations for another target compound such as an antibiotic residual. If, for example, the low concentration treatment has a 10-year cost of $8 million and removes 50% of the antibiotic while the high concentration treatment has a 10-year cost of $3 million and removes 99% of the antibiotic. The high concentration treatment would clearly be a better choice and there would be clear advantages to manipulating the concentration and contact time of dissolved ozone within the process (including varying the ozone concentration during treatment) to meet the regulatory requirements using the optimum method considering cost and other relevant targets.

The system 100 can be used to vary the ozone concentration over time beyond the capabilities of any other technology. The present invention is directed to a method for controlling the delivered concentration of dissolved ozone quickly and efficiently such that cost and treatment optimization can be done to account for different ozone generators and different treatment targets and water characteristics. Existing dissolved ozone delivery systems are based on dissolving bubbles into stationary or flowing water and are greatly limited in the range of dissolved ozone concentration that can be attained and controlled. Current dissolved ozone delivery technology is also limited to nearly steady-state use and cannot quickly adjust dissolved ozone concentrations to optimize water treatment. The delivery rate and ozone concentration of current technology is directly dependent upon the delivery rate and concentration produced by ozone generators and therefore limited in optimization of operating settings by the characteristics of the ozone generator. The system 100 system can adjust its operating parameters to quickly vary dissolved ozone concentration over a wide range to optimize efficacy and economics of treating any targets in water. The system 100 can be adjusted for pressure, water flow rate, retention time, gas flow rate, water spray, and internal mixing characteristics to allow each ozone generator to be operated at its maximum treatment efficacy conditions or lowest capital or operating costs.

In one exemplary embodiment, gas source 12 supplies oxygen to system 100 and generator 32 is an ozone generator. To control dissolution of ozone gas into the liquid flowing through the pressurized, enclosed vessel 14 while maintaining a constant flow rate of the fluid through the vessel, an operator of system 100 may increase the operating efficiency of the system by delivering an optimal concentration of dissolved ozone to the liquid at the lowest total operating cost. Additionally, the operator may manipulate the operating parameters to control the rate of ozone dissolution to achieve a desired ozone concentration downstream of discharge device 24 in stream 6.

The large number of independently variable parameters allow tailoring of system 100 operation to optimize for ozone input and/or dissolved ozone output. The total rate of dissolved ozone delivered by the system 100 is dependent upon the flow rate of water exiting the system 100 and the concentration of dissolved ozone in the water. The flow rate of water exiting the system 100 is controlled by the pressure inside the saturation tank and the number and size of orifices penetrating the discharge device located in the body of water being treated. For a discharge device with a fixed number and size of orifices, as the pressure in the tank increases/decreases, the water flow rate exiting the system 100 correspondingly increases/decreases. For a constant pressure in the saturation tank an increase/decrease in the number and/or size of orifices in the discharge device will result in a corresponding increase/decrease in flow rate exiting the system 100. Therefore, the rate of dissolved ozone added to a body of water can be varied by either independently varying saturation tank pressure and number and size of orifices in the discharge device or varying saturation tank pressure and number and size of holes together to allow the delivery rate of dissolved ozone to be controlled.

One method of increasing dissolved gas concentration in the fluid passing through pressure vessel 14 is to increase the pressure within vessel 14, thus allowing a higher concentration of gas to be dissolved. But as operating pressure increases, some commercially available ozone generators produce a gas which decreases in gas ozone concentration.

The inventors have discovered a method of producing the highest possible dissolved ozone concentration with a given ozone generator 32. The first step is to obtain data showing the gas-phase ozone concentration at various pressures. This data may be obtained either from the literature provided by ozone generator manufacturers, or by developing it experimentally by measuring the concentration at various pressures. For several data points, the gas concentration, expressed as a mole-fraction, is multiplied by the pressure at that concentration, which yields a partial pressure. The maximum partial pressure will correspond to the maximum dissolved concentration in the liquid passing through pressure vessel 14. Operating pressure vessel 14 at this pressure will produce the highest possible dissolved ozone concentration for the particular generator 32. Often, at the determined pressure, the commercially available generator produces a lower-than-maximum gaseous ozone concentration.

The rate of dissolved ozone delivered by the system 100 also depends upon the concentration of dissolved ozone in the water stream exiting the system 100. If the concentration is increased/decreased for a constant water flow rate, then the total delivery rate of dissolved ozone is also correspondingly increased/decreased. The concentration of dissolved ozone in the water stream exiting the system 100 is dependent upon the partial pressure of ozone gas in the headspace of the saturation tank, and the rate the ozone gas dissolves into the water flowing through the ozone gas headspace in the saturation tank including both water spray particles and the turbulent mixing between the gas headspace and liquid level at the bottom of the saturation tank.

Partial pressure of ozone gas in the headspace is dependent upon the controlled pressure within the tank and the concentration of ozone in the gas entering the saturation chamber from the ozone generator. The feed gas entering the ozone generator is typically oxygen or air. The greater the concentration of oxygen in the feed gas the greater the concentration of ozone exiting the ozone generator and entering the saturation chamber. The concentration of ozone in the gas exiting the ozone generator and entering the saturation chamber is dependent upon specific characteristics of the ozone generator as ozone generators can use differing methods for producing ozone. Typically, the flow rate of feed gas affects the concentration and mass flow rate of ozone exiting the ozone generator. An increase in gas flow rate increases the mass flow rate of ozone exiting the generator, but as feed gas flow rate increases, the concentration of ozone produced in the gas is less. Gas pressure can also affect concentration of ozone produced. Typically, higher pressure results in lower ozone concentration in the gas produced by the ozone generator. As gas flow rate increases through ozone generators, the concentration of ozone gas produced can be increased by increasing the current to the corona discharge element (for this specific type of ozone generator) allowing some adjustment to increase concentration of ozone gas produced as gas flow rate increases. Ozone generators are typically sized to deliver a specific mass flow rate (kg per day) at a specified ozone concentration (typically 8-15% ozone for oxygen feed gas). The relationship between gas flow rate and ozone concentration produced can be somewhat manipulated for a given ozone generator by lowering gas flow rate to increase concentration while optimizing current to the corona discharge element. However, the relationship between current to the corona element, gas flow rate, pressure, and ozone concentration produced cause design decisions to be made to account for tradeoffs between these factors for specific ozone generator units. For a specific ozone generator, the interactions between the factors affecting ozone gas concentration and mass flow rate can be optimized only with in a narrow range because of the design tradeoffs made for this particular unit. Therefore, each ozone generator model has a typical curve for ozone mass flow rate, concentration, power consumed, and pressure. Different design decisions are made by different manufacturers resulting in different production/concentration curves for ozone generators made by different manufacturers.

The inventors have also determined that a pressure vs. dissolved ozone gas concentration correlation can be developed, which allows an operator to control the concentration of dissolved ozone by adjusting the pressure of vessel 14. In one exemplary embodiment, this correlation can be programmed into programmable logic controller or other control device 34 interfacing with system 100 to allow for automated adjustment of dissolved ozone delivered to pressure vessel 14 based on the adjusted operating pressure of the vessel.

Another way to increase the total amount of dissolved gas in the liquid passing through pressure vessel 14 is to vary the liquid flow rate through the vessel. By lowering the flow rate of the liquid, the mass transfer efficiency between the gas phase and the liquid phase increases, approaching the maximum concentration—as determined by chemical equilibrium. Increasing the flow rate reduces the dissolved concentration of the gas in the liquid, but the total mass of dissolved gas leaving the pressure vessel will increase because of the higher liquid flow rate through system 100. The liquid flow through pressure vessel 14 can be used as a carrier to a second, larger water stream. As a result, the flow rate that provides the highest mass of dissolved gas to be transferred also provides the minimum operating cost for the collective water stream to be treated. The flow rate through pressure vessel 14 is dictated by the number and size of orifices used in an outlet pipe through which liquid flows out of pressure vessel 14. Control over the flow rate can be achieved by a series of effluent orifice tubes. Discharge to the orifice tubes may be controlled by a plurality of automated block valves. When more of the automated block valves are opened, higher flow rates can be achieved. To accommodate the changing number of open orifices, the flow rate of the liquid must be adjusted by varying the speed of pump 4, using a variable frequency drive, or by a throttling valve on the inlet of pressure vessel 14.

Retention time in pressure vessel 14 can be increased by increasing the size of the vessel. This will allow more gas-liquid contact, improving the transfer efficiency. Location of the gas-liquid interface, position and type of spray nozzles, and internal characteristics of the vessel, such as mixers or baffles, can also be altered to allow a greater gas-liquid interface, thus increasing mass transfer. Control of the dissolution concentration can also be achieved by varying the height of the gas-liquid interface.

Liquid temperature can also be used to optimize or control the concentration of dissolved gas leaving pressure vessel 14. The characteristics will depend on the gas-liquid combination being used in the system. In general, gases are more soluble in liquid at lower temperatures; by using a colder liquid, or by cooling the liquid passing through pressure vessel 14, more gas can be dissolved into the liquid as it passes through the vessel.

The rate headspace gas dissolves in the water with in the saturation tank is dependent upon partial pressure of ozone gas in the headspace as well as spray particle surface area, spray particle retention time in the gas headspace, volume of gas headspace in the saturation tank, mixing turbulence characteristics of the liquid water in the bottom of the saturation tank composed of collected water spray no longer in atomized form and the gas in the saturation tank headspace entrained within the water as bubbles.

The spay particle area can be controlled by the spray nozzle type and pressure drop across the nozzle for a given flow rate of water. Spray particle retention time can be controlled by increasing or decreasing the gas volume in the headspace of the saturation tank. Volume of the gas headspace can be controlled by changing the volume of the saturation tank relative to the flow rate of water through the saturation tank at steady state at the time of design and manufacture of the system 100 unit. During operation, the volume of the gas headspace in the saturation chamber can be changed by changing the level setting on the level controller that causes the feed pump to increase or decrease water flow rate into the saturation chamber until the desired level is obtained.

The turbulent mixing of the water layer at the bottom of the saturation tank and entrained gas is dependent upon the water spray direction and velocity and relative volume of water to gas within the tank. The greater the spay velocity and direct impact on the water, the greater the movement and mixing of the liquid layer and gas headspace. The lower the ratio of water to gas volume in the saturation tank, the greater the likely transfer of ozone gas to dissolved ozone in the water. The water turbulence and ozone gas transfer rate can be controlled by spray nozzle orientation, shape and size; saturation tank shape set during design and construction of the System 100; and water level set by the level controller.

Typical ozone generators currently on the market using oxygen as the feed gas produce a greater/lesser mass flow rate of ozone and lower/higher ozone gas concentration as feed gas flow rate increases/decreases. For a few ozone generators (such as Absolute Ozone) the current feed to the discharge ring can be changed to slightly increase ozone production as feed gas flow rate changes.

For ozone generators connected to and feeding ozone/oxygen gas to the system 100, the feed gas flow rate into the system 100 is in communication with the gas both entering and exiting the ozone generator and the gas flow rate through the ozone generator is thereby the same as the gas flow rate into the system 100 once density changes are taken into account if the system is sealed with no mass entering or exiting the system between the ozone generator and system 100 saturation tank. Therefore, for the closed system with no bleed off or mass addition, the gas flow rate through the ozone generator is controlled by the rate total gas in the system 100 saturation chamber headspace is absorbed by the water stream passing through the system 100. Therefore, the gas flow rate through the ozone generator can be controlled by system 100 operating points that determine gas absorption by the water stream. Since the gas flow rate through the ozone generator determines mass flow rate of ozone produced and ozone gas concentration, these characteristics can be increased or decreased within the possible range of operation for any specific ozone generator by changing in the operation of the system 100 alone.

Gas absorption rate by the water in the system 100 saturation chamber can be controlled by the following system 100 operating settings: water flow rate; saturation tank pressure; number and size of orifices in discharge device; saturation tank volume; level setting of water/gas interface on level controller in saturation tank; size, type and stream direction of spray nozzle(s); bleed off of gas from saturation tank; water temperature; valve or other flow reducing mechanisms in contact with water flowing to or from the system 100. The relationship between all of these operating settings and dissolved ozone mass flow rate and concentration, system 100 feed gas ozone mass flow rate and concentration can be accurately quantified such that engineering design can be done accurately.

The advantage of controlling the characteristics of mass flow rate of ozone and ozone concentration from the ozone generator feeding the system 100 is that these characteristics can be optimized for treatment efficacy, operating costs, and capital costs to tailor a system design (system 100 plus ozone generator) for a specific application. This advantage is make possible because of the ability of the system 100 to create much greater concentrations of dissolved ozone than current technology on the market. System 100 output has been measured up to 25 mg/L and deduced by indirect measurement up to 80 mg/L. Theoretical saturation concentration of dissolved ozone exiting the System 100 can exceed 150 mg/L. These high concentrations are simply not possible or practical using current on the market ozone delivery technologies.

Dissolving ozone gas under pressure in a spray of water in a sealed container allows dissolved ozone concentration to attain values much closer to saturation data. The high ozone concentrations attainable using the system 100 provides a range of treatment operation and control far beyond that existing. This provides a valuable tool to improve and optimize treatment processes to oxidize organisms and undesirable compounds in water. Current ozone generators on the market are designed to operate at much lower dissolved ozone concentrations using bubble entrainment or injection. By modifying the operating parameters of the ozone generators by system 100 operation through pressure and gas flow, existing on the market ozone generators can be integrated into the system 100 system to create a far more effective treatment at lower cost than existing systems. For example, for treatment options where a high concentration of 20 mg/L short time treatment is best, the system 100 design would include operational settings such that the gas flow rate through the ozone generator would be such that a higher concentration of ozone gas is produced even though this results in a ozone mass flow rate that is below the maximum rated capacity of the specific generator (that occurs at a higher gas flow rate and corresponding lower concentration). In other words, the treatment process may require 100 kg/day dissolved ozone delivered, but the ozone generation rated capacity may be 120 kg/day. This operation will cost more in initial capital because of the reduced mass flow rate compared to maximum capacity, but the operating cost savings or additional treatment capabilities will offset this added capital to make the entire system less costly over the lifetime of the equipment. The system 100 is capable of making this be low maximum capacity operation of the ozone generator work economically because the operation of the system 100 is able to use the higher ozone gas concentration to create a high dissolved ozone concentration in the water being treated.

Bubble based technology is limited to much lower dissolved ozone concentration in the water being treated because of lower pressure and less efficient gas transfer than the system 100. For the bubble based delivery systems, a higher ozone concentration in the gas bubbles does not result in a sufficiently higher dissolved ozone concentration at treatment such that the reduced capacity of the generator required to provide higher concentration and the resulting increase in capital cost is paid for by operating cost savings or improved treatment. For the system 100 system, the ozone generators are operating below maximum mass flow rate capacity because the operation of the system 100 created the lowest cost option where the benefits of higher dissolved ozone concentration created by the system 100 result in lower lifetime costs and justify increased capital costs of using ozone generators operating below maximum capacity.

Each of the methods described above may be programmed into control device 34 or any other programmable logic controller. For example, two or more operation modes may be programmed into the control device, where each operation mode differs in the vessel pressure, liquid flow, liquid temperature, or liquid level set points present in pressure vessel 14. Any of these operating parameters may be used to control the amount of dissolved gas in the second, receiving portion of the liquid, using a commercially available instrument appropriate for detection of the gas in the liquid and modulating the controlled parameter through the programmable logic controller or other device 34.

The systems and methods described in this disclosure improve upon the systems and methods described in U.S. Pat. No. 7,255,332. That patent describes systems and methods for dissolution of a gas into a liquid. The system disclosed includes a dissolution tank with a pressure vessel for containing a treatment fluid and providing a pressurized gas headspace above the treatment fluid. The dissolution tank also includes at least one liquid spray nozzle that permits passage of a source fluid into the pressure vessel, and an outlet for the treatment fluid. The system also includes pressurized fluid means or other means for transporting the source fluid into the dissolution tank, which is in fluid communication with the at least one liquid spray nozzle. A source of gas is also in communication with the dissolution tank. Additionally, at least one discharge device, external to the dissolution tank, is connected to the tank via the fluid outlet. Each discharge device is provided with one or more orifices through which treated fluid can pass from the dissolution tank and into a region external to the apparatus. An entrainment means may also be provided in communication with the one or more orifices.

The system introduces small droplets of treatment fluid into a pressurized gaseous headspace in the dissolution tank, which permit almost instantaneous absorption of gas into the fluid to near saturation at the elevated pressure inside the dissolution tank. Droplets of fluid saturated with dissolved gas fall to the bottom of the dissolution tank to form a reservoir supply of treated fluid, which acts as a seal between the pressurized gas headspace and ambient pressure. The treated fluid supply is continuously injected into and mixed with the target fluid being treated at a controlled rate for a specific application. Fluid leaving the discharge device undergoes a large pressure and energy drop, because of the energy used for controlled mixing of the treatment fluid with the target fluid.

Mixing can be controlled to produce target concentrations of dissolved gas in the bulk target fluid. Liquid-liquid mixing rates control the delivery of dissolved gas over a range of concentrations as compared with previous delivery methods that entail control of gas-liquid mixing rates. Liquid-liquid mixing can enhance delivery efficiency and efficacy in a variety of applications. The discharge device can be arranged such that a supersaturated or hyperconcentrated fluid stream is rapidly mixed with the target fluid and liquid-liquid mixing occurs. The proper mixing ratio of supersaturated or hyperconcentrated fluid with bulk target fluid ensures that the dissolved gas remains in solution.

Alternatively, the supersaturated or hyperconcentrated fluid stream can be introduced to the target fluid with minimal mixing such that the excess gas leaves solution in the form of bubbles. The size of these bubbles can be controlled as desired for different applications. The only gas used in the system is the gas that is dissolved into the liquid spray and that exits the dissolution chamber. No gas is used that is not dissolved into the fluid leaving the device and entering the target fluid. Furthermore, the system is able to operate without the use of gas recovery equipment. Preferred gases for use with the previous invention include oxygen, air, and ozone.

When compared to the system described in U.S. Pat. No. 7,255,332, system 100 has the ability to control dissolved gas delivery with much greater precision. In an embodiment of system 100 that uses ozone, the operator is able to use ozone generator performance information to identify the optimal operating conditions for system 100.

Whereas previous systems sought to maximize gas transfer efficiency, system 100 allows for a range of gas transfer efficiency—from minimal to maximal—which allows system 100 to be used in a wider range of applications than was possible with prior systems, particularly applications using a flow-through system, where control of dissolved gas delivery and control of liquid flow are both paramount to the proper operation of the system. System 100 is more conducive to such applications because two parameters—liquid flow and gas delivery—are now being controlled by the same system.

The wide range of applications in which system 100 can be used includes, but is not limited to, the following: membrane bioreactors, sequencing batch reactors, water treatment systems, wastewater treatment systems, and ecological remediation systems that require a range of dissolved gases in their processes, including, but not limited to, oxygen, ozone, carbon dioxide, hydrogen, nitrogen, and air.

As discussed above, the inventors have determined through experimentation that system 100 is capable of delivering ozone concentrations up to 25 mg/L, and deducing by indirect measurement up to 80 mg/L ozone. The saturation concentration of dissolved ozone exiting the system and method for dissolving gases in liquids can exceed 150 mg/L. These high concentrations allow higher CT factors—concentration multiplied by retention time—to be used in disinfection installations, thus achieving higher levels of disinfection or ozonation. System 100 also allows lower retention times to be used to achieve the same level of disinfection with a smaller contact chamber, which reduces capital cost.

It will be apparent to those skilled in the art that numerous other variations of the described system for optimizing the dissolution of a gas into a liquid are possible without departing from the scope of the invention.

The invention claimed is:

1. A system for optimizing the dissolution of a gas in a liquid comprising:
(a) a dissolution tank comprising:
(i) a pressure vessel for containing a treated fluid and providing a regulated gas head space comprising at least one gas above the treated fluid,
(ii) at least one liquid spray nozzle that permits passage of an untreated fluid into the gas head space under conditions effective to dissolve the gas in the untreated fluid, and
(iii) an outlet that permits passage of the treated fluid out of the pressure vessel;
(b) means for passing the untreated fluid into the dissolution tank in communication with the at least one liquid spray nozzle;
(c) a gas source in communication with the dissolution tank;
(d) a discharge device external the dissolution tank in communication with the outlet, which discharge device is provided with at least one orifice through the treated fluid from the dissolution tank can be released into the target liquid external the discharge device; and
(e) at least one control device in communication with the dissolution tank.

2. The system of claim 1, wherein said at least one control device is capable of adjusting the pressure within the vessel.

3. The system of claim 1, wherein said at least one control device is capable of adjusting the flow rate of the untreated fluid into the vessel and the flow rate of the treated fluid out of the vessel.

4. The system of claim 1, wherein said at least one control device is capable of adjusting the retention time of the at least one gas and the treated fluid in the vessel.

5. The system of claim 1, wherein said at least one control device is capable of adjusting the flow rate of at least one gas into the vessel.

6. The system of claim 1, wherein said at least one control device is capable of adjusting a liquid spray pattern of the spray nozzle.

7. The system of claim 1, wherein said at least one control device is a programmable logic controller.

8. A method for optimizing the dissolution of a gas in a liquid, the method comprising the steps of:
(a) pressurizing an enclosed vessel with gas from a gas generator;
(b) spraying an untreated liquid into the vessel containing the gas under conditions effective to dissolve the gas in the untreated liquid;
(c) discharging a treated liquid from the vessel into a target liquid;
(d) interfacing at least one control device with the vessel, wherein the at least one control device is capable of adjusting at least one parameter; and
(e) adjusting at least one parameter within the pressure vessel, wherein said adjustment is effective to change the amount of gas dissolved in the untreated liquid.

9. The method of claim 8 wherein the gas generator is interfaced with the vessel to regulate the amount and the type of gas that enters the vessel.

10. The method of claim 8, wherein the step of adjusting at least one parameter includes determining the optimal partial pressure of gas in the vessel based on a characteristics of the gas generator.

11. The method of claim 8, wherein the step of adjusting at least one parameter includes controlling pressure within the vessel.

12. The method of claim 11, further comprising controlling the pressure within the vessel using a pressure regulator that interfaces with the vessel.

13. The method of claim 10, wherein the step of determining the optimal partial pressure comprises using a specific correlation developed for the gas generator.

14. The method of claim 8, wherein the step of adjusting at least one parameter within the pressure vessel comprises controlling the flow of gas into the vessel by using a control sequence programmed into a programmable logic controller interfacing with at least one of a gas generator, a pump, a pressure regulator, and the vessel.

15. The method of claim 8, wherein the step of adjusting at least one parameter within the pressure vessel includes varying the liquid flow rate in the pressure vessel using a discharge nozzle attached to an outlet of the pressure vessel, the discharge nozzle having a plurality of precision-drilled orifices.

16. The method of claim 15, wherein the vessel includes a plurality of discharge nozzles.

17. The method of claim 16, wherein the nozzles include actuated block valves to open and close flow to nozzles and adjust the flow of liquid to the vessel.

18. The method of claim 8, wherein the step of adjusting at least one parameter within the vessel includes varying the liquid flow rate using a pump with a variable frequency drive to pump liquid into the vessel.

19. The method of claim 8, wherein the step of adjusting at least one parameter within the vessel includes adjusting dissolved gas concentration by adjusting the gas-liquid surface area within the vessel.

20. The method of claim 8, wherein the step of adjusting at least one parameter within the vessel includes adjusting the liquid temperature within the pressure vessel.

21. The method of claim 8, wherein the step of adjusting at least one parameter within the vessel includes adjusting the retention time of liquid within the vessel by changing the size of the gas-liquid interface.

22. The method of claim 21, wherein the size of the gas-liquid interface is changed using at least one of a baffle and a mixer.

23. The method of claim 21, wherein the size of the gas-liquid interface is changed by varying the position of the injection nozzles within the vessel.

24. The method of claim 21, wherein the size of the gas-liquid interface is changed by varying the number of injection nozzles within the vessel.

25. The method of claim 8, wherein the step of adjusting at least one parameter within the vessel includes adjusting the pressure of the gas in the gas headspace.

26. The method of claim 8, wherein the step of adjusting at least one parameter within the vessel includes adjusting the concentration of gas entering the vessel.

27. The method of claim 8, wherein the step of adjusting at least one parameter within the vessel includes adjusting the rate of the gas dissolving in the untreated fluid.

28. The method of claim 8, wherein the step of adjusting at least one parameter within the vessel includes adjusting the spray particle surface area.

29. The method of claim 8, wherein the step of adjusting at least one parameter within the vessel includes adjusting the bleed-off of the gas from the vessel.

30. The method of claim 8, wherein the step of adjusting at least one parameter within the vessel includes adjusting the fluid spray pattern of a fluid spray nozzle.

31. The method of claim 8, wherein the step of adjusting at least one parameter within the vessel includes adjusting the internal mixing of the untreated fluid and the gas.
